(19) United States
(12) Patent Application Publication
(10) Pub. No.: US 2020/0105263 A1
(43) Pub. Date: Apr. 2, 2020

(54) METHOD FOR GRAPHICAL SPEECH REPRESENTATION

(71) Applicant: Benjamin E. Barrowes, Hanover, NH (US)

(72) Inventor: Benjamin E. Barrowes, Hanover, NH (US)

(21) Appl. No.: 16/587,808

(22) Filed: Sep. 30, 2019

Related U.S. Application Data
(60) Provisional application No. 62/738,777, filed on Sep. 28, 2018.

(51) Int. Cl. G10L 15/22; G06F 3/16; G10L 25/90; G10L 25/18; G10L 15/02

(52) U.S. Cl. CPC G10L 15/22; G06F 3/167; G10L 25/90; G10L 2015/027; G10L 15/02; G10L 2015/223; G10L 2015/025; G10L 25/18

(57) ABSTRACT

The present invention provides a method for generating a graphical user interface capable of reproducing, using purely visual means, the tone, pacing, and volume of speech. This may be used to reproduce the original sense of the speech, such as for language training, or to convey the impression of the speech for users unable to hear. The transcribed speech is reproduced as text, with representations of at least one of the timing, pitch, volume, or other speech characteristics.

### CROSS-REFERENCE TO RELATED APPLICATIONS

This application claims priority to U.S. Provisional application Ser. No. 15/139,841, filed Sep. 27, 2018, the contents of which are incorporated by reference in their entirety.

### BACKGROUND

This invention relates to a method of transformation of speech into a non-audible representation, specifically, the transformation into graphical information displaying at least one of time and frequency information, and the display of such a representation on a user interface

Ever since humans began to make a record of their speech, spoken words as recorded through history convey only the strict meanings of the words. The manner, method, timing, amplitude/volume, pitch, fundamental frequency, tone, etc. (hereafter summarized as “manner”) of how the words were spoken were by and large lost unless described at length separate from the actual spoken words, or later the spoken words were recorded electronically (e.g. digital file) or mechanically (e.g. phonograph). For words on a two dimensional medium (clay, paper, electronic screens, etc.), writers both past and present span extremes such as recording only the spoken words (speech transcriptions, stenographers, playwrights like Shakespeare) to recording only a few lines of spoken words followed by describing the manner of how those words were spoken, in a ratio often smaller than 1 to 20 (e.g. Nathaniel Hawthorne). The transcription of tonal speech, such as Chinese, can be very difficult due to a lack of easily understandable tonal notation.

It is a problem known in the art that tools for conveying the manner in which words were spoken are rare and inadequate such as punctuation marks, the ratio of capital to lowercase letters, and modern-day emoticons. While an exclamation mark, or multiple exclamation marks, can convey enhanced feeling such as excitement or a large amplitude of the spoken words, the amplitude according to time of each spoken word is not conveyed to the reader. While a question mark indicates that the speaker has asked the question, information about the manner in which the question was asked is lost. The manner in which a question was asked, for example, may indicate that the question is rhetorical, or that the speaker expected the listener to know the answer, or that the speaker is impatient that the listener did not know the answer, or that the speaker has a calm demeanor, or that the speaker is angry, or any number of other possible scenarios. Other punctuation such as commas, semicolons, dashes, colons, and so forth have incrementally allowed writers to convey slightly more information as they record spoken words. However, the vast majority of information related to the manner in which spoken words were delivered is lost unless separately described by the recorder of the words.

Reading is still a ubiquitous human activity, distinct from video input that includes both visual and aural information, and distinct from listening to spoken words via aural input directly to the auditory systems, i.e. live speech or audio recordings. Despite reading's ubiquity, writers often desire to convey the manner in which words were spoken to the reader. Such capability would provide added clarity in fields such as, but not limited to: transcribing spoken words into text, representing spoken words in fiction books, subtitles for foreign-language movies, learning languages especially tonal languages such as Chinese, and for representing spoken words to the deaf.

There is an unmet need for the representation of words meant to be read, and more specifically to the graphical representation of words utilizing spoken words in a method that conveys information to the reader such as the pitch of the spoken words, the timing and speed at which the spoken words were delivered, the amplitude (volume) of the spoken words, the contextual identity of the speaker, and other information including how the spoken words were delivered.

### BRIEF SUMMARY OF THE INVENTION

In accordance with one embodiment, a method creates at least one graphical representation of speech within a graphical user interface (GUI). The method analyzes the speech for content and extracts a transcription of the speech. Next, the method analyzes the speech for characteristics related to the manner in which the speech is spoken and extracts at least one of a timing of the speech as it was spoken, an amplitude of the speech as a function of the timing of the speech, a pitch of the speech as a function of the timing of the speech, and a fundamental frequency of the speech as a function of the timing of the speech. The method then correlates the transcription with at least one of the timing of the speech, the amplitude of the speech, the pitch of the speech, and the fundamental frequency of the speech. Next, the method creates at least one graphical representation by displaying a textual representation of the transcription in relation to at least one visual representation of the timing of the speech, the amplitude of the speech, the pitch of the speech, and the fundamental frequency of the speech within the GUI.

Another embodiment is a system for system for creating at least one graphical representation of speech within a GUI. The system includes a processor and a non-transitory computer readable medium programmed with computer readable code that upon execution by the processor causes the processor to execute the above method for transcribing speech into at least one graphical representation within a GUI.

Another embodiment is a GUI including a time display component showing a graphical representation of the elapsing of time, a speech display component showing a textual representation of transcribed speech, and at least one of: a pitch display component indicating gradations of pitch of the speaker's voice with respect to time, a fundamental frequency component indicating gradations of fundamental frequency of the speaker's voice with respect to time, or an amplitude display component indicating the relative amplitude of the speech with respect to time. A viewer can discern the relative pitch, fundamental frequency, and/or amplitude at each moment in the GUI.

The method represents spoken words so that readers of those words can comprehend to a certain extent the manner in which the words were spoken, for example the timing, pitch, amplitude, type of speech, speaker identification, etc. The method of this representation of spoken words includes a graphical framework around or near the words with markings meant to indicate various levels of pitch (usually on the vertical axis), or fundamental frequency, of the voice that spoke the words. This graphical framework also can include markings meant to indicate the passage of time (usually on the horizontal axis) as the words were spoken. The method of this representation of spoken words also can include a method to represent the amplitude or volume of the spoken words as a function of time. This method of representation also may convey other information such as speaker identification using means such as the color of the spoken words or the font or other means. This method of representation may also convey information about the manner in which the words were spoken, to include but not be limited to, whether the speaker was whispering either by color of the spoken words or font of the spoken words or alteration of the shaded area or some other means, whether the speaker was only thinking the words but would have spoken them in the manner represented by this method either by font or color or some other means, whether the speaker was singing either by the color or font of the words or other markings near the words or some other means, whether multiple speakers/thinkers were speaking or interrupting simultaneously, and other types of verbal communication by either varying characteristics of the words or the shaded region or other markings near the text in or near the graphical framework, or some other means.

### BRIEF DESCRIPTION OF THE DRAWINGS

FIG. 1 illustrates an exemplary embodiment of a GUI for displaying spoken words within a graphical framework.

FIG. 2 illustrates a second example of spoken words within a graphical framework according to the graphical speech representation system.

FIG. 3 illustrates a third example of spoken words within a graphical framework according to the graphical speech representation system.

FIG. 4 depicts an exemplary embodiment of a system for creating and/or displaying spoken words within the graphical framework of the graphical speech representation system.

### DETAILED DESCRIPTION

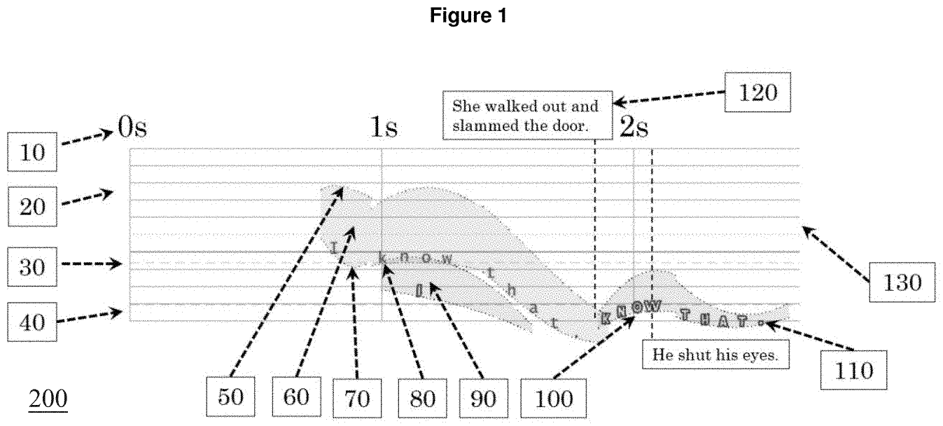

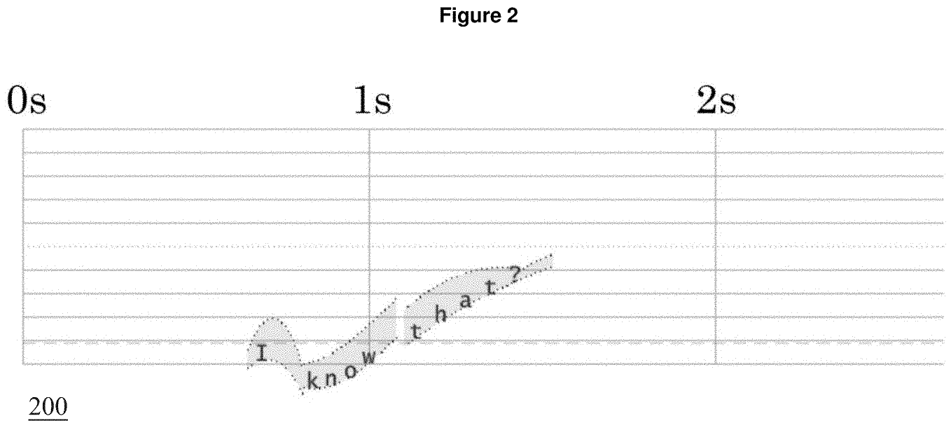

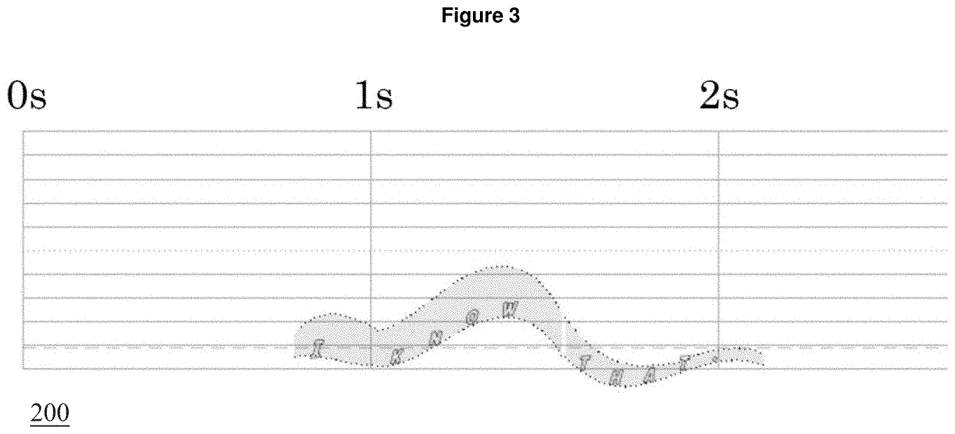

FIG. 1 illustrates an exemplary embodiment of a graphical user interface (GUI) 200 for displaying spoken words within a graphical framework. In the exemplary embodiment, the GUI 200 displays multiple speakers saying the words, “I know that.” In this case the first set of words include font and shading that are both red indicating the identity of this speaker, a female speaker distinct and different than the speaker in FIGS. 2 and 3. In this case, the female speaker says the words more slowly, with a falling pitch at the end, and with level but large amplitude over time, conveying to the reader in a calm, matter-of-fact, firm voice that she does in fact know that information. Simultaneously, the male speaker, shown in blue, thinks to himself (indicated by an outlined, fuzzy font) “I know that” overlapping with the female speaker's voiced words. In this case, the male speaker thinks the word, “I” followed by a brief pause, then concludes with the two words, “know that” emphasizing with a higher amplitude both of the words, “I” and “know” conveying to the reader that the speaker clearly and unequivocally thinks that he does in fact know that information.

FIG. 2 illustrates another example of spoken words within a graphical framework according to the graphical speech representation system, in this case, a speaker saying the words, “I know that.” In this case, the male speaker says the words quickly, with a rising pitch, with a level amplitude over time, conveying to the reader that the person speaking these words is asking a question, surprised that he is expected to know that information. In this case the font and shading are both blue to indicate the identity of this speaker in the context of the writing.

FIG. 3 shows a third example of spoken words within a graphical framework according to the graphical speech representation system, in this case, a speaker saying the words, “I know that.” In this case, the male speaker whispers calmly but emphasizes the word “know” to convey to the reader that the speaker has been told this information before and is impatient, if not threatening to listeners to believe him. In this case, the font is an outlined, comic style font (as an example) indicating that these words were whispered and by the same speaker as in FIG. 2.

FIG. 1 illustrates an exemplary embodiment of the GUI 200. The GUI 200 includes a spatial representation of a female speaker represented by red shading and text and of a male speaker represented by blue shading and text. The GUI 200 includes a time display component 10 (a spatial representation of an elapsing time), a pitch display component 20 (a spatial representation of graded pitch), a mean pitch display component 30/40 (an indication of the average or mean pitch of the female speaker 30 and of the male speaker 40), an amplitude display component 50 (a representation of the amplitude or volume of the speech as a function of time), a linear pitch representation 70 (a spatial representation of the continuous pitch of the speaker's voice, which may be a part of the pitch display component 20), an area display component 60 (a representation of the area between the linear pitch representation 70 and the amplitude component 50), and a speech display component 80 (the textual representation of the words spoken). In certain embodiments, a representation of the fundamental frequency (F₀) of the speaker's voice may replace or be included in addition to the pitch display component 20 and the linear pitch representation 70.

As can be seen from FIG. 1, the actual text of the male speaker's speech (labelled as 90 and 100 for clarity) in a different style of font indicating that it is thought inside the male speaker's mind and not actually voiced. FIG. 1 also includes punctuation 110 as used in normal speech representation, an annotation display 120 below the pitch display component 20 allowing for prose description simultaneously with graphical speech representation, and a representation of nonterminating graphical speech 130.

In the exemplary embodiment shown, the elapsing time of the time display component 10 is indicated by vertical bars at regular intervals with time indications above each vertical bar. This gives the viewer or reader a sense of elapsing time as the representation of the words moves from left to right, or in other embodiments from top to bottom, right to left, or any other orientation. This time display component 10 may or may not have time markers (“0 s”, “1 s”, and so on) as in FIG. 1-3, and may be demarcated by vertical bars or other demarcation or no demarcation in other embodiments.

In the exemplary embodiment the pitch display component 20 is indicated by horizontal lines similar to a common musical grand staff consisting of a trouble clef and a base clef where middle C is indicated by a lighter dotted line. This spatial representation of graded pitch is a graphical backdrop upon which a graphical representation of speech, the timing of that speech, the words of that speech, and the amplitude of that speech as well as other aspects concerning the manner of that speech are all portrayed. The space between from one horizontal line to the next horizontal line in the pitch display component 20 roughly corresponds to two half steps in musical art, though in other embodiments fewer horizontal lines may be used or no horizontal lines. In this embodiment, the very lowest horizontal line corresponds to G₂ or 97.99886 Hz, while the uppermost horizontal line corresponds to F₅ or 698.4565 Hz.

In the exemplary embodiment the most common or mean pitch of a speaker's voice is represented as the mean pitch display component 30/40 by a horizontal dashed line of the same color as that speaker's speech display component 80 and the area display component 60 between the linear pitch representation 70 of the speech as a function of time and the amplitude display component 50 as a function of time. This is represented on the pitch display component 20 as a reference for the viewer so that the viewer can discern whether speech is higher or lower in pitch than the average for that speaker, though in other embodiments this representation of the most common or mean pitch of the speaker's voice may not be present.

Similar to the mean pitch display component 30 of the female voice, the mean pitch display component 40 of the male speaker is represented by a horizontal dashed line in the same color as the other graphical components for that speaker. In other embodiments, this horizontal line may not be present.

In this exemplary embodiment the amplitude display component 50 is represented graphically as a dotted line above the dashed line forming the linear pitch or fundamental frequency representation 70 of the speech. This amplitude display component 50 is shown during all times corresponding to voiced speech in an electronic data record 300 or other means of storage of the speech from which the transcription, amplitude, pitch, and/or fundamental frequency of this graphical representation is extracted. The time for which speech is voiced can be extracted from the data record 300 and correlated to the other components of the graphical representation by means of computer software or some other means such as, but not limited to manual review and timing.

The distance in the GUI 200 between the linear pitch representation 70 and the amplitude display component 50 corresponds to the amplitude of that speech as a function of time. This distance gives the viewer an idea of how loud the speech is at that moment in time relative to other speech. The dotted line representing the amplitude display component 50 may be smoothed by some means or left on smoothed according to the method of extraction from the data record 300. It is well known in the art that human hearing is roughly correlated to the logarithm of the amplitude of the sound waves entering the ear canal. Therefore, the amplitude display component 50 is scaled according to the logarithm of the amplitude in the data record 300 but may be scaled by other formulae in different embodiments. Other means of representing the amplitude of the speech include but are not limited to, the height of the letters corresponding to that part of the speech, the thickness of the letters corresponding to that part of the speech, the relative transparency of the area display component 60 between the fundamental frequency of the speech 70 and the amplitude display component 50, or by some other means.

In this exemplary embodiment the shaded area display component 60 between the linear pitch representation 70 and the amplitude display component 50 gives the viewer a visual cue as to who is speaking and the amplitude at which they are speaking or yelling, etc. or the amplitude at which they would speak their thoughts if they were voicing their thoughts as is the case with the male speaker in FIG. 1. This shaded region is colored with a specific color corresponding to a specific speaker in this embodiment, however in other embodiments, this area could be indicated by cross hatching, different patterns, other means, or by no graphical representation other than the boundaries formed by the linear pitch representation 70 and the amplitude display component 50.

The pitch (or the fundamental frequency) of the speech as extracted from the data record 300 or other storage is indicated in this exemplary embodiment as a dotted line linear pitch representation 70 situated directly below the text of the speech. This dotted line of pitch of the linear pitch representation 70 follows the continuous pitch of the speech moment to moment as extracted from the speech by computer software or some other means. The linear pitch representation 70 may be smoothed as a function of time or left unsmoothed. This linear pitch representation 70 is displayed on the GUI 200 only during times of voiced speech (or thought speech as in the case of the male speaker in FIG. 1) and is absent otherwise, indicating to the viewer that there would be “audible” (whether thought or spoken) speech during that time in the GUI 200.

The speech display component 80 is represented in the GUI 200 in this exemplary embodiment as English consisting of Romanized characters. Other alphabets may be used, including braille, and the text may include phonetic or non-phonetic spelling. These characters are split up into words with horizontal spacing keyed to the timing of the beginning of those words (and potentially syllables) as compared to the time display component 10 and as extracted from the data record 300 by computer software or other means. The vertical placement of each letter within the speech display component 80 is determined by the pitch or fundamental frequency of the speech in accordance with the pitch display component 20 and potentially in addition the linear pitch representation 70.

In the exemplary embodiment of FIG. 1, the color of these letters corresponds to the color of a specific speaker, red for the female speaking first in FIG. 1, and blue for the male thinking speech in FIG. 1. The font of the letters making up the speech display component 80 may be varied in order to portray different characteristics concerning the manner of the speech. For example, the font of the male speaker in FIG. 1 is an outline font with fuzzy boundaries indicating in this exemplary embodiment that this is a thought on the part of the male speaker but that if it was spoken it would sound as represented graphically in the GUI 200. As another example, FIG. 3 represents a different font that is not fuzzy in outline that in this exemplary embodiment represents whispered speech that would have the amplitude display component 50 and linear pitch representation 70 represented graphically if it had been spoken. The letters of the speech display component 80 may also be varied in other ways such as font size, shadow or no shadow, width, height, slant, orientation, patterning, or other means representing different aspects of the manner of the speech as part of the GUI 200. The choice of font and other characteristics of the speech display component 80 could indicate parts of the manner of the speech which could include but is not limited to: whispering, thoughts, spoken, singing, shouting, etc.

In this exemplary embodiment a second speaker thinks some speech 90 at times overlapping with another speaker who actually voices speech in the combined the GUI 200. Any number of speakers may be represented in this GUI 200 distinguished by characteristics of the GUI 200 such as but not limited to color, visual intensity, or pattern of parts of the system, font of the text, characteristics of the font, or some other means, or with no distinguishing characteristics in which case the viewer would have to deduce which speaker corresponded to each graphical representation of speech. The relative timing of each speaker is indicated according to the time display component 10 and all other characteristics regarding the manner of each speaker's speech. Thus, characteristics of the conversation and manner of speech can be discerned by the viewer such as but not limited to interruptions, shouting down others, children's voices, emotions such as impatience, etc.

The fundamental frequency or pitch of the male speaker's thought speech is represented in a similar manner to the fundamental frequency or pitch of the female speaker. Due to the differences in the pitch of the two speakers, their simultaneous thoughts and speech can both be discerned by the viewer although overlapping speech is also possible in this GUI 200.

In this exemplary embodiment punctuation in the text of the speech 110 is still used as in text not in a GUI 200. Punctuation in this GUI 200 serves the same purpose as speech viewed in other media. This allows the viewer or reader to ignore this GUI 200 if they so choose. Viewers may do this if they cannot get used to this GUI 200, if they do not like this GUI 200, if they would rather imagine the manner of the speech in their own mind without this graphical representation of speech, or for some other reason. Thus, this GUI 200 adds information that the reader or viewer may utilize but does not detract from the level of information found in other media.

In this exemplary embodiment the annotation display 120 directly above and below this GUI 200 can be used to provide greater context to the viewer or reader of events that happen according to and registered with the time display component 10. According to the annotation display 120 afforded for extra explanatory events, FIG. 1 shows that according to text above the GUI 200, the female speaker timed an action of walking out and slamming the door to the end of her speech of “I know that.” Directly after that, about a quarter second later, text in the space below the GUI 200 is used to time the action of the male speaker shutting his eyes to the time that that male speaker thinks the word “know.” In this GUI 200, complex interactions including speech and events represented in the annotation display 120 can be depicted.

This pitch display component 20 indicates that the conversation continues on 130 to the next GUI 200. As in this case, if there is more speech to be represented, usually on a separate representation below or to the side of the current GUI 200. Graphical user interfaces which use side-to-side (e.g. tickertape) scrolling might not use nonterminating representation 130 and instead employ a continuous time display component 10.

The GUIs 200 may, in various embodiments, be provided using various two-dimensional indicia such as, but not limited to, different colors, different line or area thickness or fill pattern. In certain embodiments for visually-challenged reader, the GUIs 200 may have varying three-dimensional configurations and/or patterns allowing a user to detect the representations in the GUI 200 using touch. By way of non-limiting example, the representation of the area display component 60 between the fundamental frequency or pitch and the amplitude may be raised to allow a blind speaker to detect the amplitude display component 50 and the linear pitch representation 70, while the speech display component 80 may be in Braille lettering within the raised representation of the area display component 60 between the fundamental frequency or pitch and the amplitude. Conversely, the lines for the pitch display component 20 may be depressions to provide contrast and prevent them from interfering with the raised areas.

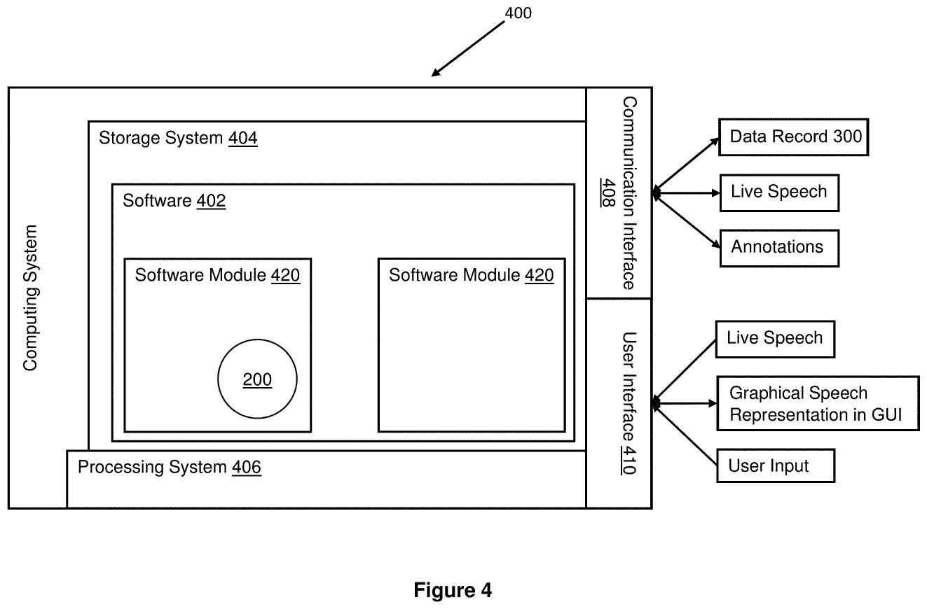

FIG. 4 depicts an exemplary embodiment of a system 400 for creating and/or displaying spoken words within the graphical framework of the GUI 200.

The system 400 is generally a computing system that includes a processing system 406, a storage system 404, software 402, a communication interface 408, and a user interface 410. The processing system 406 loads and executes software 402 from the storage system 404, including a software module 420. When executed by computing system 400, software module 420 directs the processing system 406 to operate as described in herein in further detail in accordance with the method for using the GUI 200.

The computing system 400 includes a software module 420 for performing the functions necessary to display the GUI 200. Although computing system 400 as depicted in FIG. 4 includes one software module 420 in the present example, it should be understood that more modules could provide the same operation. Furthermore, certain embodiments using additional voice-capture, voice-recognition, voice-transcription, or any other software may include additional software modules 420. Similarly, while the description as provided herein refers to a computing system 400 and a processing system 406, it is to be recognized that implementations of such systems can be performed using one or more processors, which may be communicatively connected, and such implementations are considered to be within the scope of the description. It is also contemplated that these components of computing system 400 may be operating in a number of physical locations.

The processing system 406 can comprise a microprocessor and other circuitry that retrieves and executes software 402 from storage system 404. The processing system 406 can be implemented within a single processing device but can also be distributed across multiple processing devices or sub-systems that cooperate in existing program instructions. Examples of processing systems 406 include general purpose central processing units, application specific processors, and logic devices, as well as any other type of processing device, combinations of processing devices, or variations thereof.

The storage system 404 can comprise any storage media readable by processing system 406, and capable of storing software 402. The storage system 404 can include volatile and non-volatile, removable and non-removable media implemented in any method or technology for storage of information, such as computer readable instructions, data structures, program modules, or other information. The storage system 404 can be implemented as a single storage device but may also be implemented across multiple storage devices or sub-systems. The storage system 404 can further include additional elements, such a controller capable of communicating with the processing system 406.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to store the desired information and that may be accessed by an instruction execution system, as well as any combination or variation thereof, or any other type of storage medium. In some implementations, the storage media can be a non-transitory storage media. In some implementations, at least a portion of the storage media may be transitory. Storage media may be internal or external to system 400, and removable from or permanently integrated into system 400.

As described in further detail herein, computing system 400 receives and transmits data through communication interface 408. The data can include at least one GUI 200, and/or additional verbal or textual input, such as, but not limited to, real-time speech, files containing recorded speech, user modifications and annotations to the GUI 200, files containing previously-generated GUIs 200, and any other files and input necessary to create and/or modify the GUI 200. In embodiments, the communication interface 408 also operates to send and/or receive information, such as, but not limited to, information to/from other systems and/or storage media to which computing system 400 is communicatively connected, and to receive and process information as described in greater detail above. Such information can include real-time speech, files containing recorded speech, user modifications and annotations to the GUI 200, files containing previously-generated GUIs 200, and any other files and input necessary to create and/or modify the GUI 200.

The user interface 410 can include a voice input device, a mouse, a keyboard, a voice input device, a touch input device for receiving a gesture from a user, a motion input device for detecting non-touch gestures and other motions by a user, and/or other comparable input devices and associated processing elements capable of receiving user input from a user. Output devices such as a video display or graphical display can display the GUI 200, files, or another interface further associated with embodiments of the system and method as disclosed herein. Speakers, electronic transmitters, printers, haptic devices, and other types of output devices may also be included in the user interface 410. A user can communicate with computing system 400 through the user interface 410 in order to view documents, enter or receive data or information, create or modify the GUI 200, or any number of other tasks the user may want to complete with computing system 400. In particular, the GUI 200 may be printed using a two- or three-dimensional printer to provide a fixed, tangible copy of the GUI 200, such as by printing it on a sheet of paper.

What is claimed is:

1. A method of creating at least one graphical representation of speech within a graphical user interface (GUI), comprising:
analyzing the speech for content and extracting a transcription of the speech;
analyzing the speech for characteristics related to the manner in which the speech is spoken and extracting at least one of a timing of the speech as it was spoken, an amplitude of the speech as a function of the timing of the speech, a pitch of the speech as a function of the timing of the speech, and a fundamental frequency of the speech as a function of the timing of the speech;
correlating the transcription with at least one of the timing of the speech, the amplitude of the speech, the pitch of the speech, and the fundamental frequency of the speech; and
creating the at least one graphical representation by displaying a textual representation of the transcription in relation to at least one visual representation of the timing of the speech, the amplitude of the speech, the pitch of the speech, and the fundamental frequency of the speech within the GUI.

2. The method of claim 1, wherein the textual representation of the transcription is displayed as a function of time.

3. The method of claim 1, wherein the textual representation of the transcription is a phonetic representation.

4. The method of claim 1, further comprising visually annotating the graphical representation with additional information.

5. A graphical user interface (GUI) comprised of:
a time display component showing a graphical representation of the elapsing of time;
a speech display component showing a textual representation of transcribed speech; and
at least one of:
a pitch display component indicating gradations of pitch of the speaker's voice with respect to time, whereby the viewer can discern the relative pitch at each moment in the graphical user interface,
a fundamental frequency component indicating gradations of fundamental frequency of the speaker's voice with respect to time, whereby the viewer can discern the fundamental frequency at each moment in the graphical user interface, or
an amplitude display component indicating the relative amplitude of the speech with respect to time, whereby the viewer can discern the relative amplitude at each moment in the graphical user interface.

6. The GUI of claim 5, wherein the time display comprises at least one of numerical indicia, units of time, or regularly spaced vertical lines.

7. The GUI of claim 5, wherein the pitch display component or the fundamental frequency component comprises at least one linear graphical representation of the pitch or the fundamental frequency of the speech as a function of time.

8. The GUI of claim 5, wherein the pitch display component or the fundamental frequency component further comprises at least one of regularly spaced horizontal lines or numerical indicia.

9. The GUI of claim 5, further comprising a mean pitch display component indicating a mean pitch of the speech for reference to the viewer.

10. The GUI of claim 5, wherein the amplitude display component comprises at least one linear graphical representation of the amplitude of the speech as a function of time.

11. The GUI of claim 5, wherein the location of each letter of the textual representation is correlated with the timing of that word and syllable within the speech and displayed as a function of time.

12. The GUI of claim 5, wherein at least one characteristic of at least one letter of the textual representation varies from at least one characteristic of at least one other letter of the textual representation to signify a different characteristic of the speech.

13. The GUI of claim 5, further comprising an area display component indicating the area between the amplitude display component and the pitch display component or a fundamental frequency component as a function of time.

14. The GUI of claim 5, further comprising an annotation display component is a graphical representation of non-speech events as a function of time.

15. The GUI of claim 14, wherein the annotation display component is located above, below, or in other proximity to the speech display component.

16. The GUI of claim 5, wherein the GUI is fixed on a tangible medium.

17. The GUI of claim 16, wherein the tangible medium is at least one sheet of paper.

18. A system for creating at least one graphical representation of speech within a GUI, comprising:
a processor; and
a non-transitory computer readable medium programmed with computer readable code that upon execution by the processor causes the processor to execute a method for transcribing speech into at least one graphical representation within a GUI, the method comprising:
analyzing the speech for content and extracting a transcription of the speech;
analyzing the speech for characteristics related to the manner in which the speech is spoken and extracting at least one of a timing of the speech as it was spoken, an amplitude of the speech as a function of the timing of the speech, a pitch of the speech as a function of the timing of the speech, and a fundamental frequency of the speech as a function of the timing of the speech;
correlating the transcription with at least one of the timing of the speech, the amplitude of the speech, the pitch of the speech, and the fundamental frequency of the speech; and
creating the at least one graphical representation by displaying a textual representation of the transcription in relation to at least one visual representation of the timing of the speech, the amplitude of the speech, the pitch of the speech, and the fundamental frequency of the speech within the GUI.

19. The system of claim 18, further comprising a printer capable of printing said graphical representation within the GUI in a fixed, tangible medium.

20. The system of claim 19, wherein the printer is capable of three-dimensional printing in a fixed, tangible medium.
